(19) United States
(12) Patent Application Publication
(10) Pub. No.: US 2013/0297381 A1
(43) Pub. Date: Nov. 7, 2013

(54) METHOD AND SYSTEM FOR MANAGING A LOW-RESOURCE SUPPLY CHAIN

(71) Applicants: Anup AKKIHAL, Bangalore (IN); Arun RAMANUJAPURAM, Bangalore (IN)

(72) Inventors: Anup AKKIHAL, Bangalore (IN); Arun RAMANUJAPURAM, Bangalore (IN)

(73) Assignee: LOGISTIMO INDIA PRIVATE LIMITED, Bangalore, Karnataka (IN)

(21) Appl. No.: 13/547,063

(22) Filed: Jul. 12, 2012

(30) Foreign Application Priority Data
May 7, 2012 (IN) 1752/CHE/2012

(51) Int. Cl. G06Q 10/06; G06Q 30/06; G06Q 30/02; G06Q 10/04; G06Q 10/08

(52) U.S. Cl. 705/7.31; 705/14.4; 705/14.49

(57) ABSTRACT

A method and system for managing a low-resource supply chain. The method includes receiving data over unreliable mobile networks from a retailer, identifying a pattern of goods consumption based on at least one of the data and multiple historical transactions associated with the retailer, calculating an expected demand of goods, providing personalized recommendations, to the retailer, based on the expected demand of goods, enabling the retailer to place one or more orders based on the plurality of personalized recommendations and processing the one or more orders, of the retailer, by using services provided by one or more vendors. The system includes an electronic device that enables a retailer to place one or more orders, a communication interface in electronic communication with the electronic device, a memory that stores instructions, and a processor including a transaction management module, a data management module, a personalized recommendation module and an incentive management module.

### REFERENCE TO PRIORITY APPLICATION

This application claims priority from Indian Non-provisional Application Serial No. 1752/CHE/2012 filed May 7, 2012, entitled “METHOD AND SYSTEM FOR MANAGING A LOW-RESOURCE SUPPLY CHAIN”, which is incorporated herein by reference in its entirety.

### TECHNICAL FIELD

Embodiments of the present disclosure relate to a supply chain network and more particularly to management of a low-resource supply chain using mobile devices.

### BACKGROUND

Supply chains exist to ensure delivery of goods to consumers located in rural and urban areas. Examples of the supply chains include, but are not limited to, a pharmaceutical supply chain reaching multiple medicine stores located in a city, a consumer goods supply chain reaching multiple shops located in the city and a grocery supply chain reaching multiple grocery stores located in the city. Examples of the goods include, but are not limited to, medicines, grocery, consumer goods, agricultural seeds, construction materials, magazines and electronic devices. Typically, a supply chain management is hierarchical in nature. Goods from a manufacturer are passed on to a distributor for distributing to multiple wholesalers. The distributor, for example, can be a national level distributor or a state level distributor. The goods from the wholesalers are sold to multiple retailers. Further, the multiple retailers distribute the goods to multiple consumers. Intermediaries, for example transporters, are used for shipping the goods from the distributor to the retailers.

The supply chains in cities are efficiently managed as resources are sufficiently available. Examples of the resources include, but are not limited to, fair road infrastructure, skilled people with marketing intelligence and using electronic devices for managing the supply chains. Efficient supply chain management reduces occurrence of stock-out and over-stock conditions. The efficient supply chain management also ensures availability of the goods to the consumers in a timely manner.

On another hand, multiple ad-hoc supply chains exist for delivering the goods to consumers located in rural areas. The distributors distribute the goods to one or more retailers located in a rural area. The retailers subsequently sell the goods to the consumers. However, the ad-hoc supply chains lack visibility into market conditions and hence demand and supply is unknown, thereby resulting in stock-out and over-stock conditions. Further, the ad-hoc supply chains do not support delivery of goods, in a timely manner, due to lack of available transport resources to the rural area. The transport resources are unavailable as cost of fuel and labor, to deliver the goods to the rural area, by the distributor, is higher than revenue gained by selling the goods. Consequently, the retailers travel to a nearest town or a warehouse to pick-up the goods. However, unreliable transport and poor road infrastructure requires the retailers to shut the shop and pick up the goods from the nearest town or the warehouse leading to losses and high opportunity costs.

Further, the retailers manning the ad-hoc supply chains are less skilled in using the electronic devices for managing business. Also, the users do not have sufficient time to track transactions, occurring over a time period, to place orders for the goods approaching a stock-out condition. This results in human errors while placing an order or while performing a stock update, thereby leading to stock-out condition of the goods and poor quality of service to the consumers. Further, current supply chain management methods do not provide a market to producers located in rural areas for selling the goods.

In the light of the foregoing discussion, there is a need for a method and system for an efficient technique to manage low-resource supply chains using electronic devices.

### SUMMARY

The above-mentioned needs are met by a method and a system for managing a low-resource supply chain.

An example of a method of managing a low-resource supply chain includes receiving data from a retailer. The data includes at least one of a purchased goods data and a sold goods data within a specified time interval. The method also includes identifying a pattern of goods consumption based on at least one of the data and a plurality of historical transactions associated with the retailer. The method further includes calculating an expected demand of goods. The expected demand of goods is being calculated based on at least one of the pattern of goods consumption and a plurality of attributes existing in an environment of the retailer. Further, the method includes providing personalized recommendations, to the retailer, based on the expected demand of goods. Furthermore, the method includes enabling the retailer to place one or more orders based on the personalized recommendations. The one or more orders include a plurality of goods of varying quantities. Moreover, the method includes processing the one or more orders, of the retailer, by using services provided by one or more vendors.

An example of a system for managing a low-resource supply chain includes an electronic device that enables a retailer to place one or more orders. The system also includes a communication interface in electronic communication with the electronic device. The system further includes a memory that stores instructions. Further, the system includes a processor including a transaction management module to receive a set of requests. The set of requests are being transmitted over a communication network. The processor also includes a data management module to manage data entered by the retailer. The data is being managed based on at least one of frequency and correctness of the data entered. The processor further includes a personalized recommendation module for providing personalized recommendations to at least one of a plurality of retailers, a plurality of vendors, a plurality of manufacturers, a plurality of sales agents and a plurality of transporters, the personalized recommendations are used to perform one or more actions corresponding to at least one of the personalized recommendations. Further, the processor includes an incentive management module for providing one or more incentives to at least one of the plurality of retailers, the plurality of vendors, the plurality of manufacturers, the plurality of sales agents and the plurality of transporters.

### BRIEF DESCRIPTION OF THE VIEWS OF DRAWINGS

In the accompanying figures, similar reference numerals may refer to identical or functionally similar elements. These reference numerals are used in the detailed description to illustrate various embodiments and to explain various aspects and advantages of the present disclosure.

FIG. 1 is a block diagram of an environment, in accordance with which various embodiments can be implemented;

FIG. 2 illustrates a block diagram of a server, in accordance with one embodiment;

FIG. 3 illustrates a block diagram of a processor, in accordance with one embodiment;

FIG. 4 illustrates a block diagram of a transaction management module, in accordance with one embodiment;

FIG. 5 illustrates a block diagram of a data management module, in accordance with one embodiment;

FIG. 6 illustrates a block diagram of a personalized recommendation module, in accordance with one embodiment;

FIG. 7 illustrates a block diagram of an incentive management module, in accordance with one embodiment;

FIG. 8 is a schematic representation of a supply chain modeled as a supply chain network, in accordance with one embodiment; and

FIG. 9 is a flowchart illustrating a method of managing a low-resource supply chain, in accordance with one embodiment.

### DETAILED DESCRIPTION OF THE EMBODIMENTS

The above-mentioned needs are met by a method and system for managing a low-resource supply chain. The following detailed description is intended to provide example implementations to one of ordinary skill in the art, and is not intended to limit the invention to the explicit disclosure, as one or ordinary skill in the art will understand that variations can be substituted that are within the scope of the invention as described.

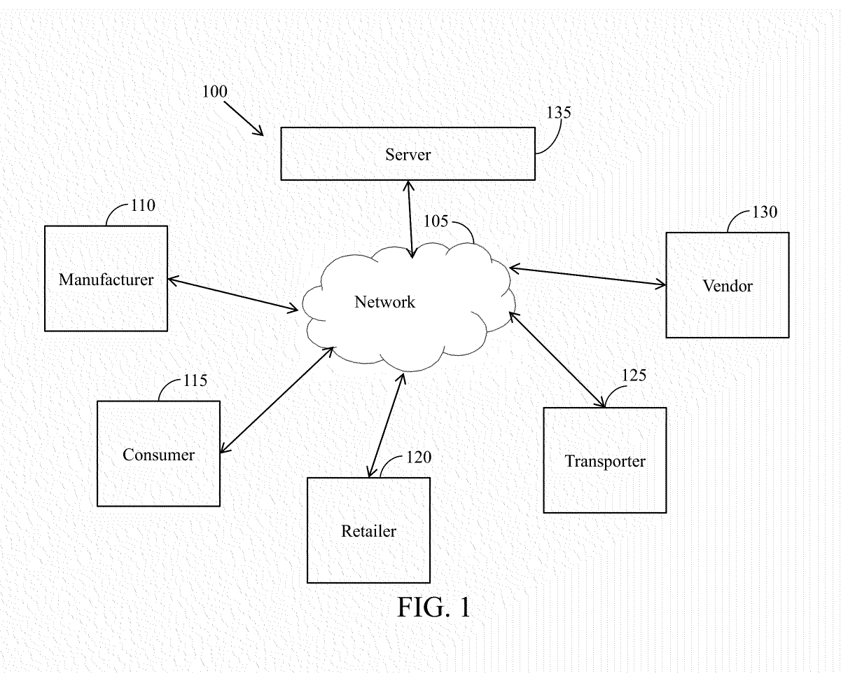

FIG. 1 is a block diagram of an environment 100, in accordance with which various embodiments can be implemented.

The environment 100 includes a network 105, a manufacturer 110, a consumer 115, a retailer 120, a transporter 125, a vendor 130 and a server 135. Examples of the network 105 include, but are not limited to, a Local Area Network (LAN), a Wireless Local Area Network (WLAN), a Wide Area Network (WAN), internet, and a Small Area Network (SAN).

In one example, the retailer 120 places an order, including one or more goods of varying quantities. In another example, a sales agent can place the order on behalf of the retailer 130. The retailer can place the order using an electronic device. Examples of the electronic device include, but are not limited to, a computer, a mobile device, a laptop, a palmtop, a hand held device, a telecommunication device and a personal digital assistants (PDAs). In one example, the order is placed by logging into an application that provides a service for managing a low-resource supply chain. In one example, the application can be downloaded in the electronic device. Log-in credentials, for example a user name and a password, are used for logging into the application. The order placed by the retailer 120 is broadcasted over the network 105 such that the manufacturer 110, the vendor 130, the consumer 115 and the transporter 125 can view the order.

The retailer 120 also provides data by performing data entry. Examples of the data includes, but are not limited to, various goods sold over a specified time interval, various goods purchased over the specified time interval and available stock of one or more goods. The data entry is performed using the electronic device. In one example, a low-end mobile phone activated with General Packet Radio Service (GPRS) or Short Message Service (SMS) can be used for performing the data entry. The data entry can be performed using multi-modal inputs. Examples of the multi-modal inputs include, but are not limited to, text input, voice input, an image and a graphical input. The data provided by the retailer 120 is maintained by the server 135. The server 135 also maintains the data indicating an inventory of goods associated with the retailer 120. The data entry performed by the retailer 120 is used to calculate an expected demand of goods for various goods in future. Calculating the expected demand of goods of goods enables the retailer 120 to stock up sufficient quantity of the goods, thereby preventing stock-out and over-stock conditions.

The vendor 130 views the order by logging into the application. The vendor 130, upon viewing the order, performs one or more actions responsive to the order placed by the retailer 120. Examples of the vendor 130 include, but are not limited to, a wholesaler, a distributor, a channel partner and a dispatcher. Examples of the actions include, but are not limited to, specifying pricing details associated with the order, confirming the order, shipping the goods included in the order, specifying one or more discounts associated with the order and rejecting the order. The actions performed are further broadcasted over the network 105 such that the retailer 120 can view the actions. The actions performed can also be transmitted as a text message or an electronic mail to the retailer 120, by the vendor 130.

In one example, the vendor 130 confirms the order, placed by the retailer 120, by transmitting the text message. Upon confirming, a two-way handshake is established between the vendor 130 and the retailer 120. Subsequently, the goods included in the order are delivered to a location of the retailer 120. The transporter 125 delivers the goods to the retailer 120. In one example, the vendor 130 places a telephone call to the transporter 125 for delivering the goods to the retailer 120. Similarly, orders placed by multiple retailers can be confirmed by the vendor 130. The orders are subsequently delivered to the retailers.

Further, the orders placed by each of the multiple retailers are aggregated. The multiple retailers can be located at one or more remote areas close to each other. Hence, a single transporter can deliver the goods, included in the orders that are aggregated, thereby making a single trip to deliver the goods to the multiple retailers located in the remote areas.

Furthermore, one or more personalized recommendations are provided to the retailer 120. The personalized recommendations convey information, to the retailer 120, for optimal management of the goods. In one example, the personalized recommendations alert the retailer 120 about an unsafe stock of goods in order to stock-up the unsafe stock of goods. In another example, the personalized recommendations alert the retailer 120 to place a new order with recommended quantities, within a time interval, to prevent the stock-out condition. Further, ordering the recommended quantities minimize various costs to the retailer. Examples of the various costs include, but are not limited to, an ordering cost spent for placing the orders, a storage cost spent for over-stocked goods and a revenue loss for under-stocked goods. The personalized recommendations are provided, to the retailer 120, based on the data entry performed by the retailer 120. A text message or an electronic mail can be used to provide the personalized recommendations to the retailer 120. The server 135 is used to maintain the personalized recommendations.

In some embodiments, a possible profit is indicated, to the retailer 120, in response to placing one or more orders, within the time interval, based on the personalized recommendations. Further, a possible loss is also indicated, to the retailer 120, when the retailer 120 fails to place the one or more orders within the time interval. The server 135 is configured to calculate the possible profit or the possible loss based on the data provided by the retailer 120.

In some embodiments, one or more incentives are provided to the retailer 120. The incentives are provided based on, but not limited to, frequency of performing the data entry, correctness of the data entry, consistency of the data entry and placing orders based on the personalized recommendations.

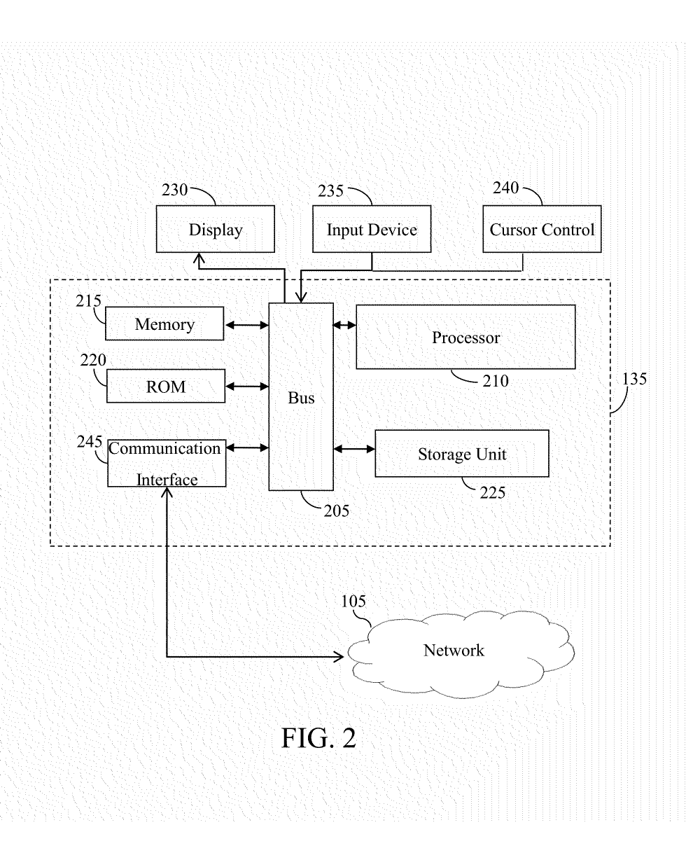

The server 135 including a plurality of elements, for managing a supply chain in a low resource environment, is explained in detail in conjunction with FIG. 2.

FIG. 2 is a block diagram of the server 135, in accordance with one embodiment.

The server 135 includes a bus 205 or other communication mechanism for communicating information, and a processor 210 coupled with the bus 205 for processing information. The server 135 also includes a memory 215, for example a random access memory (RAM) or other dynamic storage device, coupled to the bus 205 for storing information and instructions to be executed by the processor 210. The memory 215 can be used for storing temporary variables or other intermediate information during execution of instructions by the processor 210. The server 135 further includes a read only memory (ROM) 220 or other static storage device coupled to the bus 205 for storing static information and instructions for the processor 210. A storage unit 225, for example a magnetic disk or optical disk, is provided and coupled to the bus 205 for storing information for example an inventory of goods associated with a retailer and an inventory of goods associated with a vendor.

The server 135 can be coupled via the bus 205 to a display 230, for example a cathode ray tube (CRT), for displaying an inventory of goods associated with a user. The input device 235, including alphanumeric and other keys, is coupled to the bus 205 for communicating information and command selections to the processor 210. Another type of user input device is the cursor control 240, for example a mouse, a trackball, or cursor direction keys for communicating direction information and command selections to the processor 210 and for controlling cursor movement on the display 230. The input device 235 can also be included in the display 230, for example a touch screen.

Various embodiments are related to the use of the server 135 for implementing the techniques described herein. In some embodiments, the techniques are performed by the server 135 in response to the processor 210 executing instructions included in the memory 215. Such instructions can be read into the memory 215 from another machine-readable medium, for example the storage unit 225. Execution of the instructions included in the memory 215 causes the processor 210 to perform the process steps described herein.

In some embodiments, the processor 210 can include one or more processing units for performing one or more functions of the processor 210. The processing units are hardware circuitry used in place of or in combination with software instructions to perform specified functions.

The term “machine-readable medium” as used herein refers to any medium that participates in providing data that causes a machine to perform a specific function. In an embodiment implemented using the server 135, various machine-readable media are involved, for example, in providing instructions to the processor 210 for execution. The machine-readable medium can be a storage medium, either volatile or non-volatile. A volatile medium includes, for example, dynamic memory, for example the memory 215. A non-volatile medium includes, for example, optical or magnetic disks, for example the storage unit 225. All such media must be tangible to enable the instructions carried by the media to be detected by a physical mechanism that reads the instructions into a machine.

Common forms of machine-readable media include, for example, a floppy disk, a flexible disk, hard disk, magnetic tape, or any other magnetic media, a CD-ROM, any other optical media, punchcards, papertape, any other physical media with patterns of holes, a RAM, a PROM, and EPROM, a FLASH-EPROM, any other memory chip or cartridge.

In another embodiment, the machine-readable media can be transmission media including coaxial cables, copper wire and fiber optics, including the wires that include the bus 205. Transmission media can also take the form of acoustic or light waves, such as those generated during radio-wave and infra-red data communications. Examples of machine-readable media may include, but are not limited to, a carrier wave as described hereinafter or any other media from which the server 135 can read. For example, the instructions can initially be carried on a magnetic disk of a remote computer. The remote computer can load the instructions into its dynamic memory and send the instructions over a telephone line using a modem. A modem local to the server 135 can receive the data on the telephone line and use an infra-red transmitter to convert the data to an infra-red signal. An infra-red detector can receive the data carried in the infra-red signal and appropriate circuitry can place the data on the bus 205. The bus 205 carries the data to the memory 215, from which the processor 210 retrieves and executes the instructions. The instructions received by the memory 215 can optionally be stored on the storage unit 225 either before or after execution by the processor 210. All such media must be tangible to enable the instructions carried by the media to be detected by a physical mechanism that reads the instructions into a machine.

The server 135 also includes a communication interface 245 coupled to the bus 205. The communication interface 245 provides a two-way data communication coupling to the network 105. For example, the communication interface 245 can be an integrated services digital network (ISDN) card or a modem to provide a data communication connection to a corresponding type of telephone line. As another example, the communication interface 245 can be a local area network (LAN) card to provide a data communication connection to a compatible LAN. In any such implementation, the communication interface 245 sends and receives electrical, electromagnetic or optical signals that carry digital data streams representing various types of information.

The processor 210 in the server 135 is configured to receive data, including a purchased goods data and a sold goods data, from a retailer, for example the retailer 120 or a sales agent. The processor 210 identifies a pattern of goods consumption based on the data and various historical transactions associated with the retailer. The processor 210 is further operable to calculate an expected demand of goods based on the pattern of goods consumption and multiple attributes existing in an environment of the retailer. The processor 210 is further configured to provide personalized recommendations, to the retailer, based on the expected demand of goods. Further, the processor 210 enables the retailer to place one or more orders based on the personalized recommendations. The processor 210 is operable to process the one or more orders, of the retailer, by using services provided by one or more vendors.

In some embodiments the processor 210 can include an order scheduling module. The order scheduling module is operable to perform planning to process orders placed by multiple retailers for delivering the goods, to the retailers, in a timely manner. The order scheduling module is configured to schedule the orders based on, for example, but not limited to, availability of stock of goods with the vendor, delivery lead time, importunity of the retailers for receiving the goods. The order scheduling module also determines time period between placing the orders by the multiple retailers and shipment of the goods to the retailers.

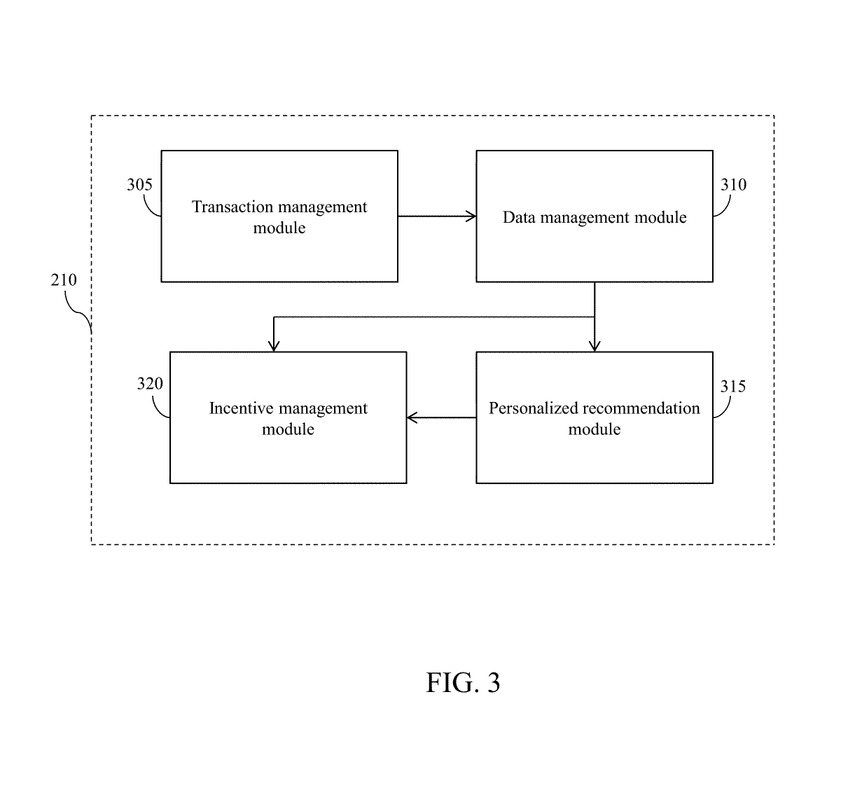

A block diagram of a processor 210 including a plurality of modules for managing a low-resource supply chain is explained in detail in conjunction with FIG. 3.

FIG. 3 illustrates a block diagram of the processor 210, in accordance with one embodiment.

The processor 210 includes a transaction management module 305, a data management module 310, a personalized recommendation module 315 and an incentive management module 320.

The transaction management module 305 enables multiple transactions between, for example, but not limited to, a manufacturer, a vendor, a consumer, a retailer and a transporter, to occur over mobile networks that are unreliable. Examples of the transactions include, but are not limited to, various goods sold, various goods purchased and physical stock count. One or more modes of communication are used for enabling the transactions over the mobile networks. Examples of the modes of communication include, but are not limited to, SMS and GPRS and voice messages. The GPRS supports internet and further ensures that large transaction data, in a transaction request, is received reliably.

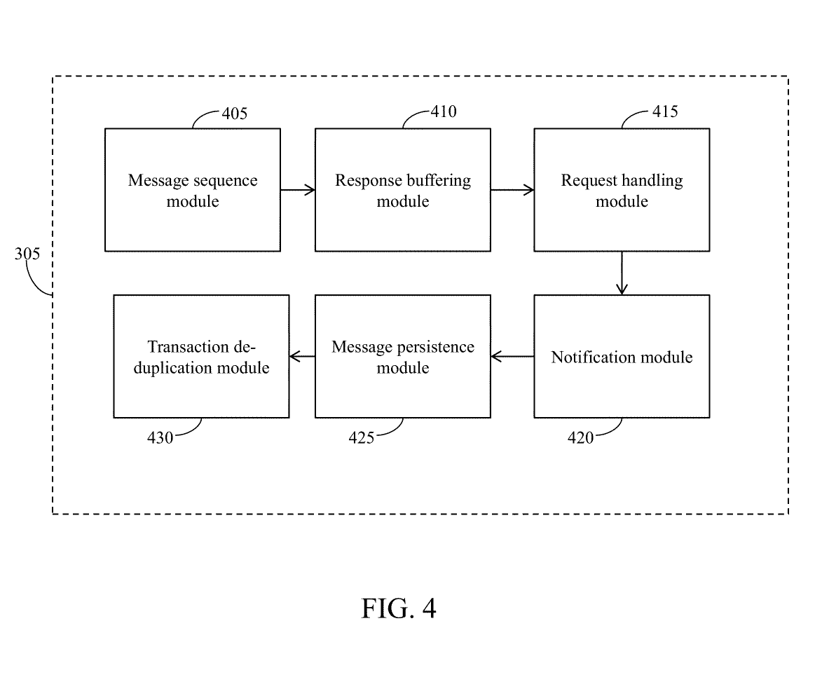

The transaction management module 305 enables robust transactions over a network. Examples of the network include, but are not limited to an unreliable communication network, and a reliable communication network. The transactions are transmitted over an SMS or unreliable Internet. In such unreliable mobile networks, a transaction request message can be lost or delayed during transmission, thus leading to significant loss of transaction data. The transaction management module 305 ensures that transaction messages can be transmitted reliably over the unreliable mobile networks. The transaction management module 305 maintains an order update and a stock update. One or more databases are required for storing the order update and the stock update. Examples of the order update include, but are not limited to, one or more orders placed by the retailer or a sales agent, the orders accepted by the vendor and goods received by the retailer. Examples of the stock update include, but are not limited to, sales performed by the retailer, goods purchased by the retailer and sales performed by the vendor. The transaction management module 305 further transmits the order update and the stock update to the data management module 310. The transaction management module 305 ensures that the transaction request is received completely without being lost during transmission, by enabling message sequencing, message buffering, message persistence and message de-duplication. Further, transactions can also be entered offline on the phone, where there is no network, and sent over the network when the network becomes available to an electronic device. The transaction management module 305 is explained in detail in conjunction with FIG. 4.

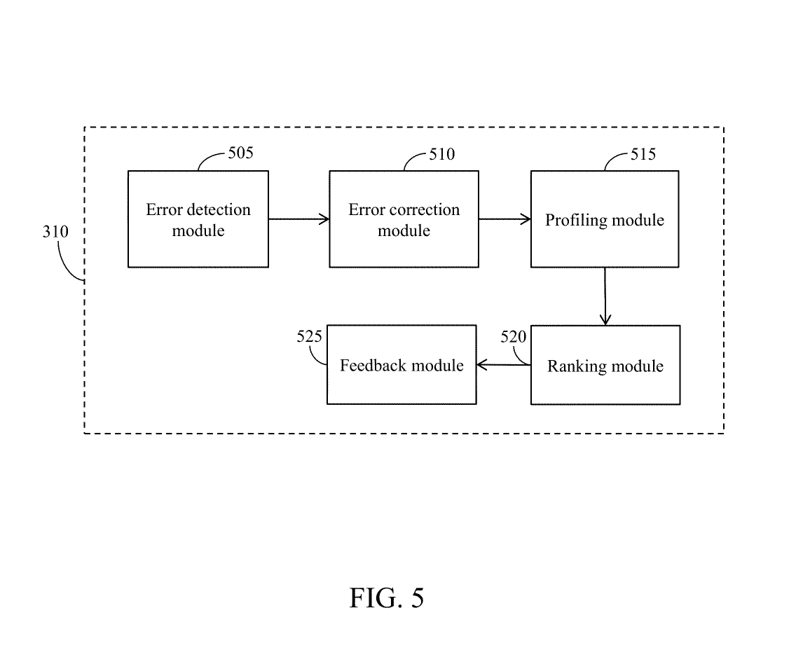

The data management module 310 ensures high-quality data acquisition from the retailer, the sales agent, a micro entrepreneur, the vendor, the manufacturer and the transporter. The data management module 310 enables the retailer or the sales agent to enter data accurately, thereby preventing erroneous entry of the data. Examples of the data include, but are not limited to, a request for placing an order, number of goods purchased by the retailer or the sales agent and number of goods sold by the retailer within a specified time interval. The data maintained by the data management module 310 is provided to the personalized recommendation module 315 for providing personalized recommendations that enables optimal management of an inventory of goods of the retailer. The data management module 310 also ensures that the retailer enters the data consistently. The data management module 310 further includes one or more error correction mechanisms for correcting errors in case of erroneous entry of the data. Further, the data management module 310 enables aggregation of the order update and the stock update for transacting and reporting purposes. The data management module 310 is explained in detail in conjunction with FIG. 5.

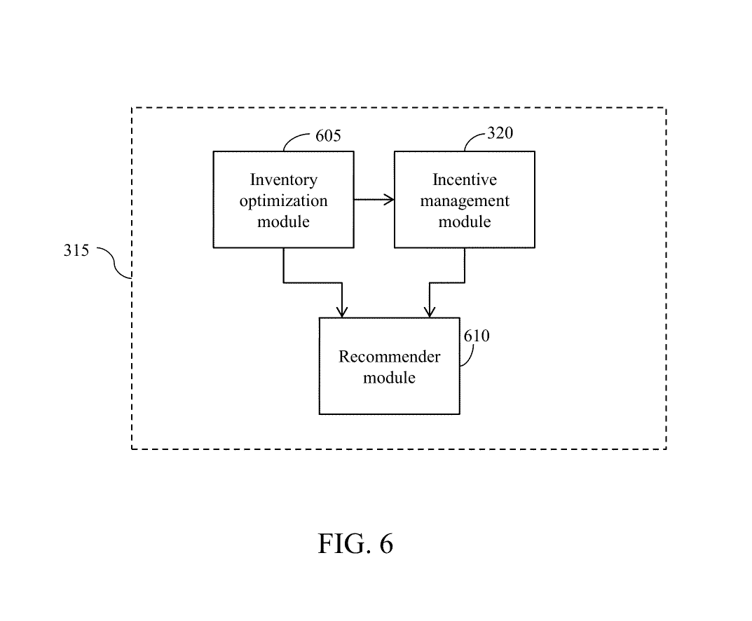

The personalized recommendation module 315 enables generation of various personalized recommendations. The personalized recommendations can be classified into two types namely order quantity recommendations and delivery route recommendations. The order quantity recommendations are created based on a combination of historical transaction data, heuristic rules and statistical models. The order quantity recommendations provide one or more recommendations, based on the data entered by the retailer, for ordering optimal quantities of required goods, thereby increasing profits of the retailers. Further, ordering optimal quantities of the required goods prevents stock-out condition thereby enabling the retailers to provide an improved quality of service to consumers. The delivery route recommendations provide one or more recommendations that include an optimal transport route for transporting goods to multiple locations. The optimal transport route ensures reduced transport cost and transport time. Further, the delivery route recommendations maximize delivery of goods to the locations including remote areas. The personalized recommendation module 315 delivers the personalized recommendations, to the retailer, through a text message or an electronic mail. The personalized recommendation module 315 employs various algorithms to provide the personalized recommendations. Further, the personalized recommendation module 315 employs an opportunity cost algorithm to determine an opportunity cost when the retailer fails to place an order based on the personalized recommendations. The opportunity cost determined is thus transmitted to the retailer through a text message or an electronic mail for taking one or more necessary actions. The personalized recommendation module 315 is explained in detail in conjunction with FIG. 6.

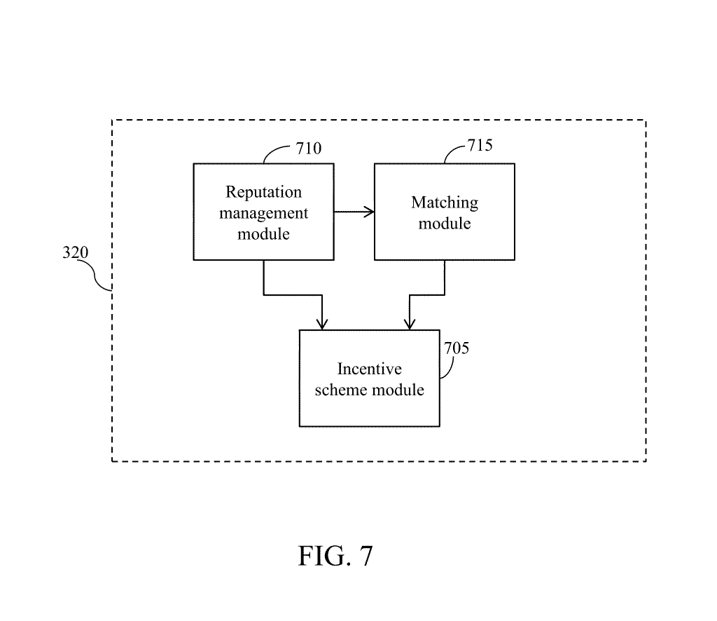

The incentive management module 320 provides one or more incentives to the retailer. The incentives can be a vendor specified incentive or a system generated incentive. The incentives are provided, to the retailer, based on past transactions performed, frequency of performing the data entry, correctness of the data while performing the data entry, a reputation score and behavior of the retailer within a community. Examples of the incentives include, but are not limited to, an economic incentive and a social incentive. Examples of the economic incentive include, but are not limited to, providing discounts, by the vendors, when goods purchased, by the retailer, exceeds a pre defined quantity, providing discounts when goods are purchased based on the personalized recommendation, and providing one or more gifts. The social incentive motivates better performance of the retailer within the community. Examples of social incentive include, but are not limited to, indicating data entry behavior of a retailer in comparison to other retailers in the community or a geographical area of the retailer. The social incentive is provided to the retailer through a text message, an electronic mail, a data packet over the Internet or a voice call. Further, the incentives can also be provided to the transporter for timely delivery of goods to the retailer. The incentive management module 320 is explained in detail in conjunction with FIG. 7.

In some embodiments, the processor 210 enables configuration of retailers, vendors, manufacturers, transporters, micro entrepreneurs and sales agents to form a supply chain network. The network includes multiple nodes and multiple arcs. The nodes represent the retailers, the vendors, the manufacturers, the transporters, the micro entrepreneurs and the sales agents. Each node is associated with other nodes for fulfilling one or more needs, for example, stocking the inventory of goods, of the node. Further, each node is associated with a reputation score. The reputation score is explained in detail in conjunction with FIG. 6. Furthermore, each node can set one or more privilege settings for permitting access to a profile associated with each node by other nodes. The arcs represent a contractual relationship between any two nodes.

FIG. 4 illustrates a block diagram of the transaction management module 305, in accordance with one embodiment.

The transaction management module 305 includes a message sequence module 405, a response buffering module 410, a request handling module 415, a notification module 420, a message persistence module 425 and a transaction de-duplication module 430.

The message sequence module 405 ensures that a set of messages transmitted over the network and delivered at different times, are in a sequential order. The message sequence module 405 combines the set of messages in a sequential order to form a transaction. Examples of the transaction include, but are not limited to, an order placed by the retailer or a sales agent, one or more goods purchased by the retailer and a message transmitted by a vendor in response to the order placed by the retailer. The message sequence module 405 leverages a sequence number and a unique identifier for each of the set of messages that are available in a message header associated with each of the set of messages to sequence the set of messages belonging to the transaction.

The response buffering module 410 buffers the set of messages obtained from the retailer. The set of messages are buffered to enable re-transmission of one or more messages that are not transmitted successfully. The response buffering module 410 also includes mechanisms to identify one or more messages, included in the set of messages, which are lost during the transaction. The one or more messages can be lost due to network errors or if network connectivity is low.

The request handling module 415 identifies if the set of messages are out-of-sequence since the one or more messages may be lost during the transaction. The request handling module 415 further provides a request, to the retailer, for re-transmitting the one or more messages that are lost during the transaction. The request handling module 415 can also handle multiple transactions from, for example, but not limited to, the vendor, the manufacturer, the transporter and the micro-entrepreneur, simultaneously.

The notification module 420 indicates, to the retailer, one or more messages from the set of messages received by the transaction management module 305. The notification module 420 also indicates the one or more messages that are missing from the set of messages, thereby prompting the user to re-transmit the messages as they can be lost during transmission. The notification module 420 also indicates a wait time to the retailer. When the wait time lapses, the notification module 420 requests the retailer to re-transmit the one or more messages to obtain the transaction completely.

The message persistence module 425 enables storage and fast retrieval of the messages for re-transmission purposes, when the network connectivity improves.

The transaction de-duplication module 430 enables detection of the transaction that is duplicated by the retailer. The transaction is duplicated since the retailer can inadvertently redo the transaction, assuming existence of an error during transmission. The transaction de-duplication module 430 analyzes a transaction type of the transaction, various goods included in the transaction and quantity of the goods included in the transaction, within a specified time interval. If multiple transactions with similar transaction type, the goods and quantity of the goods are found, then the transaction de-duplication module 430 transmits one transaction of the multiple transactions, to the retailer, along with notifications to ensure appropriate human checks and corrections, thereby preventing a single transaction to be processed multiple times. The transmission can occur through, for example, a text message, an electronic mail or a data packet over Internet.

FIG. 5 illustrates a block diagram of the data management module 310, in accordance with one embodiment.

The data management module 310 includes an error detection module 505, an error correction module 510, a profiling module 515, a ranking module 520 and a feedback module 525.

The error detection module 505 detects one or more errors in data when performing data entry. The error detection module 505 also generates one or more alert signals. The alert signals indicate, to the retailer, the errors in the data when performing the data entry.

The error correction module 510 is configured to correct the errors present in the data. One or more correction algorithms are used to enable correction of the errors. The error correction module 510 corrects the errors based on a pre-specified rule and past data entries performed by the retailer.

The profiling module 515 stores profile of, for example, but not limited to, the retailer, a vendor, a manufacturer, a transporter and a micro-entrepreneur. The profile stored by the profiling module 515 also includes data entry pattern of the retailer. Further, the profile stored by the profiling module 515 further includes a reputation score for the retailer. The reputation score is assigned based on frequency of the data entry performed by the retailer, correctness of the data entry and placement of one or more orders in adherence to the personalized recommendations.

The ranking module 520 provides a rank, to the retailer, based on the frequency of the data entry, correctness of the data entry and the reputation score. The rank provided to the retailer motivates the retailer to perform better, for example, but not limited to, entering the data frequently, entering the data correctly without errors and placing the one or more orders based on the personalized recommendations, in a community.

The feedback module 525 provides a feedback to the retailer. The feedback enables the retailer to correct the errors present in the data when performing the data entry. The feedback module 525 provides the feedback, to the retailer, through a text message or an electronic mail. Further, the feedback module 525 compares the data entry pattern of the retailer with other retailers in the community and provides the feedback, to the retailer, based on the comparison. Thereby, the feedback provided by the feedback module 525 motivates the retailer to perform the data entry without errors.

FIG. 6 illustrates a block diagram of a personalized recommendation module 315, in accordance with one embodiment. The personalized recommendation module 315 includes an inventory optimization module 605, the incentive management module 320 and a recommender module 610.

The inventory optimization module 605 is operable to provide an economic order quantity of goods. The economic order quantity of the goods is referred to as minimum quantity of the goods that requires to be stocked, by a retailer, to obtain profits. The inventory optimization module 605 is also operable to provide an optimal stock level of the goods to prevent a stock-out condition. The inventory optimization module 605 is further operable to forecast an expected demand of the goods. The inventory optimization module 605 employs data, that includes number of goods purchased by the retailer or a sales agent, number of goods sold by the retailer within a specified time interval, historical transactions of the retailer, delivery lead time and environmental parameters, for providing the optimal stock level of the goods. The delivery lead time is referred to as a time interval between placement of an order by the retailer and reception of the goods included in the order. The time interval is such that the retailer does not encounter the stock-out condition for the goods. The inventory optimization module 605 is further operable to transmit the economic order quantity of the goods, the optimal stock level of the goods and the expected demand of the goods to the recommender module 610.

The incentive management module 320 is operable to provide one or more incentive messages that include incentives to the retailer. The incentives can be a vendor specified incentive or a system generated incentive. The vendor specified incentives are encoded in the form of heuristics. The system-generated incentives are derived based on the historical transactions performed, frequency of performing a data entry, correctness of the data while performing the data entry, a reputation of the retailer and behavior of the retailer within a community. The incentive management module 320 is further operable to transmit the incentive messages to the recommender module 610.

The recommender module 610 is operable to provide various personalized recommendations to the retailer. The recommender module 610 employs the economic order quantity of goods, the optimal stock level of goods and the expected demand of goods for providing the personalized recommendations. The personalized recommendations provided by the recommender module 610 indicates to the retailer about optimal quantities of the goods that is required to be ordered by the retailer to prevent the stock-out condition for the goods and to increase profits. The personalized recommendations provided by the recommender module 610 further alerts, the retailer, of a possible profit that is acquired by placing the order based on the personalized recommendations. Further, the personalized recommendations provided by the recommender module 610 alerts the retailer, of a possible loss that is incurred in case of failure to place the order based on the personalized recommendations. The recommender module 610 is also operable to transmit the incentive messages, to the retailer, in the form of the personalized recommendations. The recommender module 610 delivers the personalized recommendations, to the retailer, through a text message, an electronic mail, data packet over Internet or a voice call.

FIG. 7 illustrates a block diagram of an incentive management module, in accordance with one embodiment.

The incentive management module 320 includes an incentive scheme module 705, a reputation management module 710 and a matching module 715.

The incentive scheme module 705 specifies one or more incentive schemes. The incentive schemes specified includes one or more incentives that are provided to a retailer. The incentives schemes are transmitted, to the retailer, through, for example, a text message, an electronic mail, data packet over Internet or a voice call. The incentive scheme module 705 also creates the incentive schemes based on, for example, but not limited to, frequency of performing data entry, correctness of the data while performing the data entry and placing one or more orders in adherence to the personalized recommendations. The incentive schemes are customized for each retailer. The incentives can also be provided based on a reputation score associated with each retailer. The incentives can also be provided to a transporter for timely delivery of goods to the retailer. The incentives schemes can be vendor specified in the form of heuristics or rules. The incentives schemes can also be system-generated based on. For example, the data entered by the retailer and placing orders based on the personalized recommendations.

The reputation management module 710 computes a reputation score for each retailer based on various attributes. The reputation score determines a reputation associated with each retailer. Examples of the various attributes include, but are not limited to, the frequency of performing the data entry, the correctness of the data while performing the data entry and placing the one or more orders based on the personalized recommendations provided by the personalized recommendation module 315 and timely payment. The reputation score associated with each retailer is used to rank the retailer among other retailers in a community.

The matching module 715 matches the incentives for each retailer with associated reputation score computed by the reputation management module 710. The incentive is matched in real-time. The matching module 715 enables the retailer to receive the incentive based on the associated reputation score.

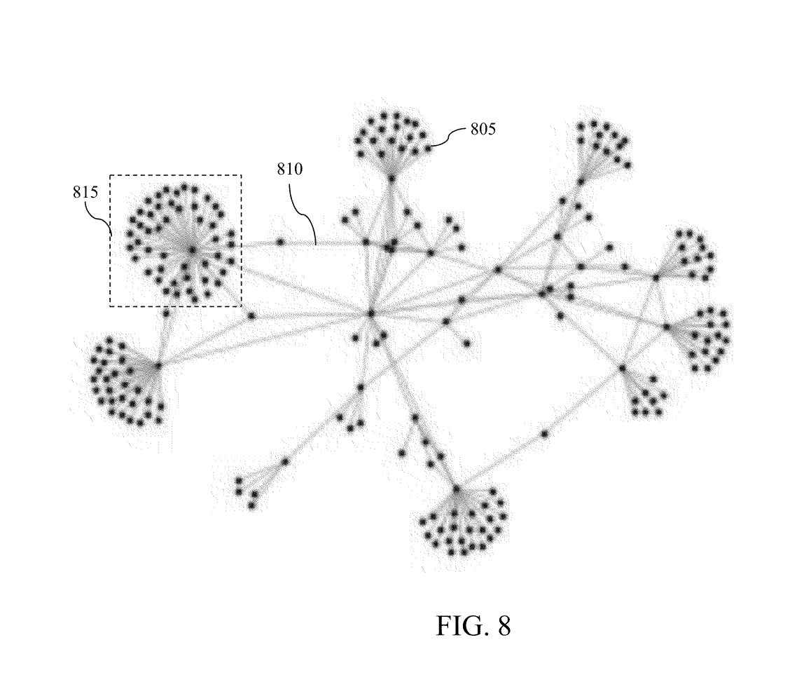

FIG. 8 is a schematic representation of a low-resource supply chain modeled as a supply chain network, in accordance with one embodiment.

The supply chain modeled as the supply chain network includes multiple nodes, for example, a node 805 and a node 820. The supply chain network further includes multiple arcs, for example an arc 810, connecting the node 805 and the node 820 present in the supply chain network. Similarly, the arcs can connect any two nodes present in the supply chain network.

In one example, the node 805 can represent, for example, but not limited to, a retailer, a sales agent a vendor, a manufacturer, a transporter, a micro-entrepreneur or a consumer. Each node in the supply chain network can also represent an enterprise associated with an inventory of goods. Various other nodes can be associated with the node 805 to fulfill needs of the node 805. The node 805 can also be associated with a reputation. The reputation, in one example, is obtained based on an ability of the node to honor various contractual relationships with the other nodes. The reputation associated with the node 805 can also be obtained using one or more feedbacks provided by the other nodes. Further, the node 805 can set permissions for viewing the inventory of goods, of the node, by the other nodes.

The arc 810 represents a contractual relationship between the node 805 and the node 820. The arc 810 further enables the other nodes to the view the inventory of goods associated with the node 805 based on the permissions. Further, the arc 810 is associated with a degree of trust existing between the node 805 and the node 820.

In some embodiments, a set of nodes can be grouped together to form a super-node 815. The super-node 815 includes similar characteristics as the node 805. The super-node 815 can act as a single entity possessing a contractual relationship with the other nodes. Grouping can be performed based on one or more attributes. Examples of the one or more attributes include, but are not limited to, a location, inventory, interest and professional attributes. One or more counts, for example stock counts of each node in the set of nodes can be aggregated using pre-defined aggregation rules. Similarly, stock receipts and payment receipts of the set of nodes can be combined as a single entity at the super-node 815. Further, another contractual relationship can be defined between the super-node 815 and another node.

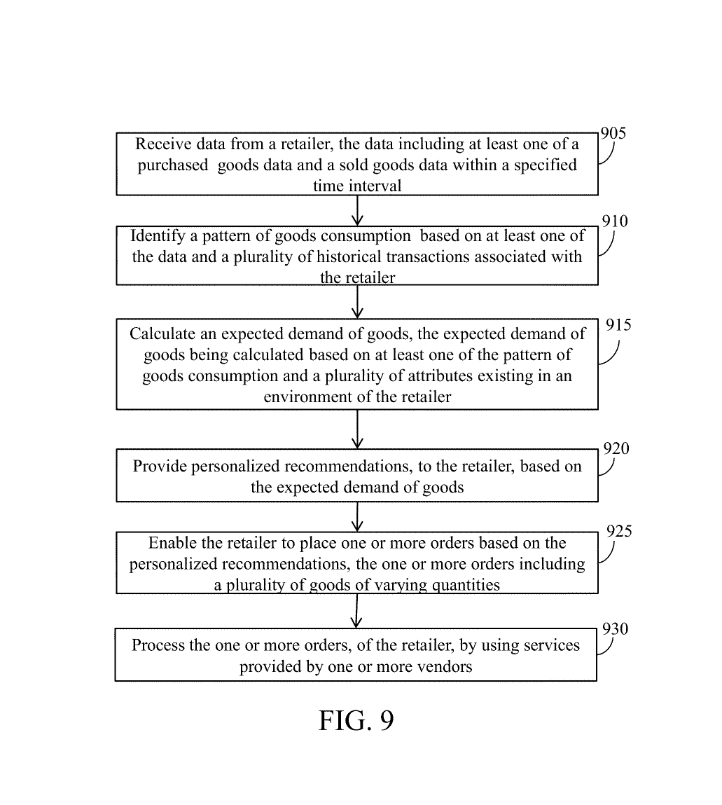

FIG. 9 is a flowchart illustrating a method of managing a low-resource supply chain, in accordance with one embodiment.

At step 905, data is received from a retailer. The data can include a purchased goods data, a sold goods data, or both within a specified time interval. The purchased goods data represents quantity of one or more goods purchased, by the retailer, within the specified time interval. The sold goods data represents quantity of one or more goods sold, by the retailer, within the specified time interval. The data can also include one or more transactions that occur between the retailer and a vendor, within the specified time interval. The data further includes a real time inventory of goods and physical stock count of the retailer. The retailer provides the data by performing data entry. The data entry is performed using, for example, but not limited to, a mobile phone or a computer. A data management module, for example the data management module 310, ensures that correct, consistent and timely, data entry is being performed by the retailer. A transaction management module, for example the transaction management module 305, is used to manage the transactions occurring between the retailer and the vendor. Similarly, the transaction management module manages the transactions that occur between multiple retailers and vendors. In one example, the retailer can register to an application that provides a service for managing a low-resource supply chain. Log-in credentials, for example a username and a password, can be used for logging into the application. The application, in one example, can be installed on the mobile phone or the computer.

At step 910, a pattern of consumption of goods is identified based on the data provided by the retailer. The pattern of consumption of goods is also identified based on transactions that occurred in past between the retailer and various vendors. The pattern of consumption of goods specifies the quantity of one or more goods purchased by the retailer for selling to multiple consumers.

At step 915, an expected demand of goods is calculated based on the pattern of consumption of goods identified at step 910. The expected demand of goods is also calculated based on various attributes existing in an environment of the retailer. Examples of the various attributes include, but are not limited to, a predicted natural disaster and road conditions. The expected demand of goods, in one example, is referred to as minimum quantity of one or more goods that requires to be stocked to prevent a stock-out condition. The expected demand of goods thus calculated is transmitted to the retailer through, for example, a text message or an electronic mail.

At step 920, one or more personalized recommendations are provided, to the retailer, based on the expected demand of goods calculated at step 915. The personalized recommendations are generated by a personalized recommendation module, for example, the personalized recommendation module 315. The personalized recommendations are provided based on the data provided by the retailer. In one example, the personalized recommendations indicate, to the retailer, a safety stock level for the one or more goods to prevent a stock-out condition for the goods. In another example, the personalized recommendations alert the retailer to order optimal quantities of the one or more goods such that the stock-out condition is prevented. In yet another example, the personalized recommendations alert the retailer about the goods approaching the stock-out condition at a specific time in future. Further, the personalized recommendations indicate, to the retailer, a possible profit that can be obtained when one or more orders are placed based on the personalized recommendations, and a possible loss that can be incurred when the retailer fails to place the orders based on the personalized recommendations. The personalized recommendations can be transmitted to the retailer via, for example, a text message, an electronic mail, data packet over Internet or voice message.

At step 925, the retailer is enabled to place one or more orders based on the personalized recommendations. The orders placed can include multiple goods of varying quantities. Examples of the goods include, but are not limited to, medicines, consumer goods, groceries, magazines and electronic devices.

In one example, the orders are placed by logging into the application using electronic devices, for example mobile phones, computers, laptops, hand held devices, telecommunication devices and personal digital assistants (PDAs). The retailer is associated with a profile. The profile can store one or more of a contact number of the retailer, address location of the retailer, past transactions of the retailer and each data entry performed by the retailer. In another example, a sales agent of a vendor can place the orders on behalf of the retailer. One or more modes of communications are used for transmitting the orders placed by the retailer. Examples of the modes of communications include, but are not limited to, short message service (SMS) and general packet radio service (GPRS). The orders can be placed using multi-modal inputs. Examples of the multi-modal inputs include, but are not limited to, text, voice and a graphical image. The orders placed by the retailer are broadcasted over the network such that, one or more vendors, manufacturers, transporters and consumers can view the orders in real time. One or more privileges can be granted, by the retailer, to the vendors for viewing the orders. Similarly, multiple retailers, registered with the application, can place multiple orders simultaneously. Further, the orders placed by the retailers are broadcasted over the network such that the vendors can view the orders and subsequently service the orders.

In one example, a list of vendors can be stored in a vendor database. The retailer can view the vendor database and further select one or more vendors, from the vendor database, for purchasing the goods. In some embodiments, the goods included in the orders can be selected from an inventory of goods associated with the vendor.

At step 930, the one or more orders placed by the retailer are processed by the one or more vendors. Processing includes identifying if the goods included in the orders are present in the inventory database associated with the vendors. The inventory database associated with the vendor includes a list of goods that are present for selling to the retailer. The processing also includes packing the goods included in the orders and further arranging for a transporter to ship the goods to the retailer. The vendors can view the orders by logging into the application using the electronic devices. Similarly, the vendors can log into the application for viewing multiple orders placed by the multiple retailers. The vendors upon viewing the orders perform one or more actions. Examples of the one or more actions include, but are not limited to, confirming the orders, specifying pricing details associated with the orders, specifying one or more discounts associated with the orders, shipping the goods included in the orders and rejecting the orders. The one or more actions are further indicated to the retailer.

In one embodiment, a text message, an electronic mail, or data packet over Internet is transmitted to the retailer for indicating the one or more actions. Further, the vendors also transmit a text message, an electronic mail or data packet over Internet including one or more negotiating terms and conditions, to the retailer, that enables the retailer to purchase the goods from the vendors using terms. Similarly, the vendors transmit a text message or an electronic mail or data packet over Internet including one or more negotiating terms and conditions to multiple retailers simultaneously.

In some embodiments the vendor can perform an order scheduling in response to receiving various orders from multiple retailers simultaneously. In one case, the vendor may not possess one or more goods included in the orders placed by the multiple retailers. In such cases, the vendor can place an order with the manufacturer for obtaining the goods with an objective to deliver the goods to the retailers. The order scheduling includes planning to process the orders placed by the multiple retailers to deliver the goods, to the retailers, in a timely manner. The order scheduling can be performed based on, for example, but not limited to, availability of stock of goods with the vendor, delivery lead time and importunity of the retailers for receiving the goods. The order scheduling also determines time period between placing the orders by the multiple retailers and shipment of the goods to the retailers.

When the retailer selects a vendor from the one or more vendors, a two-way handshake is established between the vendor and the retailer. The two-way handshake is established when the retailer accepts the negotiating terms and conditions and further decides to purchase the goods from the vendor. The two-way handshake is established to enable one or more transactions between the retailer and the vendor. Similarly, multiple two-way handshakes can be established between multiple vendor-retailer pairs.

In some embodiments, multiple orders obtained from multiple retailers are aggregated. Aggregation can be performed based on, for example, but not limited to, location, interests, inventory and professional attributes. In one example, the orders placed by the multiple retailers located close to each other are aggregated. Further, the vendor makes arrangement for a single or multiple transporters (on a multi-hop route) to ship the goods included in the multiple orders to appropriate retailers.

In some embodiments, geo-coordinates, for example latitude and longitude, of a location associated with the retailer or agent are captured. The location, in the form of geo-coordinates, is captured to identify an address location of the retailer such that an optimal route, to deliver the goods to the retailer, is identified. Similarly, locations from where one or more orders are placed are captured for delivering the goods to the appropriate retailers. In another example, the location or geo-coordinates are captured to determine if the sales agent associated with the vendor, while placing an order, is present at the address location of the retailer.

In some embodiments, one or more incentives are provided to the retailer. The incentives are provided based on, for example, but not limited to, frequency of performing the data entry, correctness of the data when performing the data entry, consistency of the data entry, placing the one or more orders based on the personalized recommendations, purchasing one or more goods beyond a pre-defined volume and timely payment for the one or more goods purchased. Further, a feedback is also provided to the retailer in case of one or more errors that occur when performing the data entry. The incentives can also be provided to the transporter for delivering the goods in a timely manner.

In one example, the vendor can place a telephone call to the transporter for delivering the goods to the retailer. In another example, the vendor can transmit a text message, to the transporter, requiring the transporter to deliver the goods to the retailer.

Upon receiving the goods, from the transporter, the retailer confirms the arrival of the goods to the vendor. The orders can be confirmed via, for example, a text message, an electronic mail or a telephone call.

In some embodiments, if multiple orders are being placed by the retailer, then the retailer can confirm the arrival of the goods by clicking a picture of the received goods using, for example, a mobile phone scanner and further can confirm the order. Upon capturing the orders, the retailer is directed to a web page that includes each of the multiple orders that were placed, thereby preventing the retailer from logging into the application repeatedly.

In some embodiments, the goods can be identified by scanning their bar codes using the camera on the mobile phone, where in, a picture of the bar-code or other identifying information of the good, is taken using the camera, and the picture is analyzed to extract any information about the good that is encoded in the bar code. The bar codes can be of any type including, but not limited to, 1D or 2D bar codes.

The method further includes configuring the retailer, the manufacturer, the vendor, the distributor, the transporter and the consumer, in the form of a supply chain network. The supply chain network includes multiple nodes and multiple arcs. The retailer, the manufacturer, the vendor, the distributor, the transporter and the consumer are represented as the nodes. An arc represents a contractual relationship between any two nodes. Each node in the supply chain network represents an enterprise holding inventory of goods. Each node is associated with multiple other nodes for fulfilling needs of the node. Each node is also associated with a reputation score. The reputation score for each node is provided based on, but not limited to, ability to honor various contractual relationships with other nodes, trustworthiness, timely payment of bills, frequency of performing the data entry, correctness of data entry and placing orders based on the recommendations. The reputation score associated with each node is used to compute a rank for each retailer. The rank of each retailer motivates the retailer, of a community, to perform better.

The method also includes re-configuring the supply chain network such that the retailer, the manufacturer, the vendor, the distributor, the transporter or the consumer can form a vendor-customer pair for each other. The method further includes aggregating a set of nodes to form a super node, for example, the super-node 815. The super node acts as a single entity in context of contractual relationships with the others nodes.

The method specified in the present disclosure enables real-time visibility into supply, demand and inventory of a retailer by broadcasting the supply, the expected demand of goods and the inventory of the retailer into a network. Broadcasting the supply, the expected demand of goods and the inventory enables the retailer to stock goods ahead of time, thereby preventing stock-out conditions. By broadcasting the orders, of the retailer, into a network, faster processing of the orders is achieved thereby providing goods, to the retailer, in a timely manner. The method also enables the retailer to easily place orders, perform data entry, broadcast the demand, broadcast the supply and to confirm orders using a low-end mobile phone. Hence, users inefficient of using electronic devices can also place the orders easily. Further, the method enables transactions to occur over unreliable networks.

The method also enables the retailer to place orders in bulk. The method further enables aggregation of multiple orders, placed by multiple retailers located in one or more remote areas. A single transporter or any person travelling to the remote areas can deliver the goods to the multiple retailers, thereby solving transportation issues in remote areas. The method further provides personalized recommendations, to the retailer, for obtaining profits by placing optimized orders, providing optimized transport routes, preventing stock-out conditions and stocking required goods ahead of time, thereby increasing quality of service to consumers. Moreover, the method provides incentives and discounts to the retailer thus motivating the retailer, of a community, to perform better. By configuring the supply chain network, system managing the supply chain can thereby adapt to logistic changes occurring in the supply chain.

It is to be understood that although various components are illustrated herein as separate entities, each illustrated component represents a collection of functionalities which can be implemented as software, hardware, firmware or any combination of these. Where a component is implemented as software, it can be implemented as a standalone program, but can also be implemented in other ways, for example as part of a larger program, as a plurality of separate programs, as a kernel loadable module, as one or more device drivers or as one or more statically or dynamically linked libraries.

As will be understood by those familiar with the art, the invention may be embodied in other specific forms without departing from the spirit or essential characteristics thereof. Likewise, the particular naming and division of the portions, modules, agents, managers, components, functions, procedures, actions, layers, features, attributes, methodologies and other aspects are not mandatory or significant, and the mechanisms that implement the invention or its features may have different names, divisions and/or formats.

Furthermore, as will be apparent to one of ordinary skill in the relevant art, the portions, modules, agents, managers, components, functions, procedures, actions, layers, features, attributes, methodologies and other aspects of the invention can be implemented as software, hardware, firmware or any combination of the three. Of course, wherever a component of the present invention is implemented as software, the component can be implemented as a script, as a standalone program, as part of a larger program, as a plurality of separate scripts and/or programs, as a statically or dynamically linked library, as a kernel loadable module, as a device driver, and/or in every and any other way known now or in the future to those of skill in the art of computer programming. Additionally, the present invention is in no way limited to implementation in any specific programming language, or for any specific operating system or environment.

Accordingly, the disclosure of the present invention is intended to be illustrative, but not limiting, of the scope of the invention, which is set forth in the following claims.

What is claimed is:

1. A method of managing a low-resource supply chain, the method comprising:
receiving data from a retailer, the data comprising at least one of a purchased goods data and a sold goods data within a specified time interval;
identifying a pattern of goods consumption based on at least one of the data and a plurality of historical transactions associated with the retailer;
calculating an expected demand of goods, the expected demand of goods being calculated based on at least one of the pattern of goods consumption and a plurality of attributes existing in an environment of the retailer;
providing a plurality of personalized recommendations, to the retailer, based on the expected demand of goods;
enabling the retailer to place one or more orders based on the plurality of personalized recommendations, the one or more orders comprising a plurality of goods of varying quantities; and
processing the one or more orders, of the retailer, by using services provided by one or more vendors.

2. The method as claimed in claim 1 and further comprising:
delivering the plurality of goods, to the retailer, from the vendor, through a plurality of transporters.

3. The method as claimed in claim 1, wherein the data provided by the retailer is used to determine an inventory of goods, of the retailer, in real time.

4. The method as claimed in claim 1, wherein the expected demand of goods indicates quantity of one or more goods that requires to be stocked, by the retailer, to prevent a stock-out condition.

5. The method as claimed in claim 1, wherein the one or more orders are broadcasted over a network.

6. The method as claimed in claim 5, wherein the network comprises at least one of a plurality of retailers, a plurality of vendors, a plurality of manufacturers, a plurality of sales agents and a plurality of transporters.

7. The method as claimed in claim 1 and further comprising:
aggregating a plurality of orders received from each of a plurality of retailers.

8. The method as claimed in claim 1 and further comprising:
capturing geo-coordinates of a location of the retailer, wherein the geo-coordinates comprises latitude and longitude of the location.

9. The method as claimed in claim 1, wherein the plurality of personalized recommendations indicates, to the retailer, at least one of a stock-out condition and an over-stock condition, at a specific time in future.

10. The method as claimed in claim 1 and further comprising:
indicating, to the retailer, a possible profit that is acquired by placing an order based on the plurality of personalized recommendations; and
indicating, to the retailer, a possible loss that is incurred in case of failure to place the order based on the plurality of personalized recommendations.

11. The method as claimed in claim 1 and further comprising:
providing a plurality of incentives to the retailer, the incentives being provided based on at least one of frequency of providing the data, correctness of the data, placing the one or more orders based on the plurality of personalized recommendations and timely payment for the one or more orders.

12. The method as claimed in claim 1 and further comprising:
configuring the low-resource supply chain to form a supply chain network, wherein the supply chain network comprises a plurality of nodes and a plurality of arcs;
enabling aggregation of the plurality of nodes to facilitate a group of transactions, the plurality of nodes representing at least one of a plurality of retailers, a plurality of vendors, a plurality of manufacturers, a plurality of sales agents and a plurality of transporters; and
providing one or more controls to view an inventory of goods associated with each of the plurality of nodes across the supply chain network.

13. The method as claimed in claim 12, wherein the plurality of arcs represents a contractual relationship existing between the plurality of nodes.

14. A system for managing a low-resource supply chain, the system comprising:
an electronic device that enables a retailer to place one or more orders;
a communication interface in electronic communication with the electronic device;
a memory that stores instructions; and
a processor comprising:
a transaction management module to receive a set of requests, the set of requests being transmitted over a communication network;
a data management module to manage data entered by the retailer, the data being managed based on at least one of frequency and correctness of the data entered;
a personalized recommendation module for providing a plurality personalized recommendations to at least one of a plurality of retailers, a plurality of vendors, a plurality of manufacturers, a plurality of sales agents and a plurality of transporters, the one or more personalized recommendations are used to perform one or more actions corresponding to at least one of the plurality personalized recommendations; and
an incentive management module for providing one or more incentives to at least one of the plurality of retailers, the plurality of vendors, the plurality of manufacturers, the plurality of sales agents and the plurality of transporters.

15. The system as claimed in claim 14, wherein the transaction management module comprises:
a message sequence module to track the set of requests, received from a retailer, in a sequential order, the set of requests being aggregated to form the one or more orders;
a response buffering module to store the set of requests, the set of requests being stored to enable retransmission of one or more request that are lost during transmission;
a request handling module configured to manage the set of requests transmitted by the retailer;
a message persistence module for enabling the retailer to re-transmit the one or more requests that are lost during the transmission; and
a transaction de-duplication module to detect one or more duplicate requests that are transmitted by the retailer.

16. The system as claimed in claim 14, wherein the data management module comprises:
an error detection module to detect an error occurring in the data;
an error correction module to correct the error;
a profiling module to store a profile associated with each of the plurality of retailers, the plurality of vendors, the plurality of manufacturers, the plurality of sales agents and the plurality of transporters, the profile further including a reputation associated with each of the plurality of retailers, the plurality of vendors, the plurality of manufacturers, the plurality of sales agents and the plurality of transporters;
a ranking module to rank the retailer, the rank being provided based on at least one of frequency and correctness of the data entered by the retailer; and
a feedback module to provide a feedback to the retailer, the feedback being provided to ensure correctness of the data entered by the retailer.

17. The system as claimed in claim 14, wherein the transaction management module and the data management module is configured to enable a plurality of transactions to occur over an unreliable communication network by automatically handling at least one of a plurality of uncertainties when transmitting the set of requests and a plurality of errors present in the data entered by the retailer, in real time.

18. The system as claimed in claim 14, wherein the personalized recommendation module comprises:
an inventory optimization module for providing at least one of an economic order quantity of goods, optimal stock level of the goods and an expected demand of goods; and
a recommender module for transmitting plurality personalized recommendations.

19. The system as claimed in claim 14, wherein the incentive management module comprises:
an incentive scheme module to specify one or more incentive schemes, the one or more incentive schemes specified for providing one or more incentives to at least one of the plurality of retailers, the plurality of vendors, the plurality of manufacturers, the plurality of sales agents and the plurality of transporters;
a reputation management module configured to compute a reputation associated with each of the plurality of retailers, the plurality of vendors, the plurality of manufacturers, the plurality of sales agents and the plurality of transporters, the reputation being computed based on one or more attributes; and
a matching module to match the one or more incentives to each of the plurality of retailers, the plurality of vendors, the plurality of manufacturers, the plurality of sales agents and the plurality of transporters, the reputation being computed based on one or more attributes based on the reputation.

20. The system as claimed in claim 14, wherein the low-resource supply chain is configured to form of a supply chain network, the network comprising a plurality of nodes and a plurality of arcs.
